(19) United States
(12) Patent Application Publication
(10) Pub. No.: US 2016/0078580 A1
(43) Pub. Date: Mar. 17, 2016

(54) Method Implemented on Portable Electronic Device to Check USCIS Application Status

(71) Applicant: Jennifer Yang, Palo Alto, CA (US)

(72) Inventor: Jennifer Yang, Palo Alto, CA (US)

(21) Appl. No.: 14/484,284

(22) Filed: Sep. 12, 2014

(51) Int. Cl. G06Q 50/26; G06F 17/28

(52) U.S. Cl. CPC G06Q 50/265; G06F 17/28

(57) ABSTRACT

A method implemented on portable electronic device for assisting users to check United States Citizenship and Immigration Services (USCIS) immigration related application status, whereby a user uses an portable electronic device to enter the receipt number of an immigration related application, retrieve the application status and detailed application status description, and display the application status and detailed status description on the portable electronic device.

### TECHICAL FIELD

The present invention relates to a method or system for assisting users to check United States Citizenship and Immigration Services (USCIS) immigration related application status from a portable electronic device, such as a smartphone, for users, who either favor the convenience of portable electronic device, or lack the necessary computer skills or English language skills to check the application status on USCIS website.

### BACKGROUND OF THE INVENTION

After an individual files an immigration related application with USCIS, an receipt number is assigned to the application, and the receipt number is provided to the applicant to track the application status. The applicant can check the status of the application on USCIS website. However, the USCIS website's main page has many tools and informational links. The link to the application status tool is provided under a menu tab, amount 20 some other tools. For someone who is not familiar with the USCIS website, it is not easy to find the link to the application status tool. When the USCIS website is viewed from a smartphone browser, the webpage contents are displayed in very small font by default. This makes it even harder to find the link to the application status tool. This situation becomes even worse for those users, who either feel less comfortable to reading English or can't read English.

The above described situation creates the need for a method or system, which provides a way to check USCIS application status from a portable electronic device, such as a smartphone, without directly visiting the USCIS website, by entering the USCIS application receipt number through a simple input dialog. For those users lacking the necessary English language skills, the method or system provides an input dialog in the user's preferred language, such as Chinese, and displays the application status in the user's preferred language.

### SUMMARY OF THE INVENTION

It is an object of the present invention to provide a method or system for assisting users, who either lack the computer skill to use the USCIS website directly or lack the necessary English language skills to use the USCIS website, to check the status of a USCIS immigration related application. It is also an objective of the present invention to provide the convenience of checking USCIS application status on a portable electronic device, such as a smartphone, anywhere and anytime the user can access the Internet through the portable electronic device. According to the present invention, the object above is achieved through a method implemented on computer based electronic devices, which can access the Internet, to collect a USCIS application receipt number through a simple input dialog. It will retrieve the application status over the Internet based on the receipt number. The application status and the detailed status description are displayed on the screen of the portable electronic device. If the user prefers to read in language other than English, the input dialog and status display will be in the user's preferred language.

A typical implementation of the present invention on a smartphone to check USCIS application status works in the following way. A users opens an application on a smartphone, the application displays an input dialog asking for a USCIS application receipt number. The user types in the receipt number and submits the request. The application retrieves the application status and the detailed status description through the Internet, and then displays the status and the detailed status description on the screen of the portable electronic device.

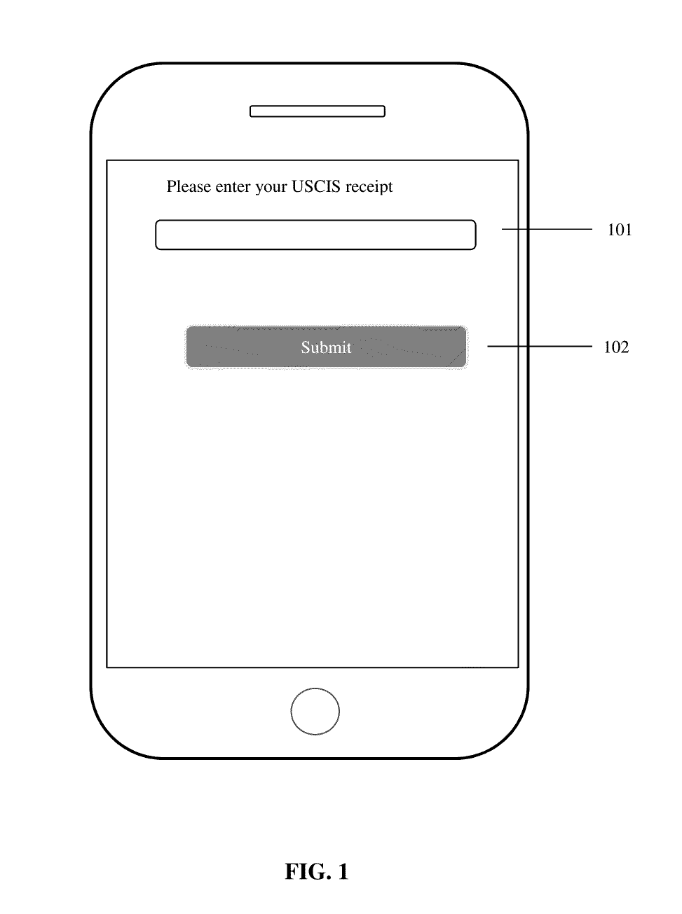

FIG. 1 is an example of a typical embodiment of the input dialog, which collects the USCIS application receipt number from the user, on a smartphone.
101 An input dialog where user can type in a USCIS application receipt number.
102 A clickable button to submit the status inquiry request.

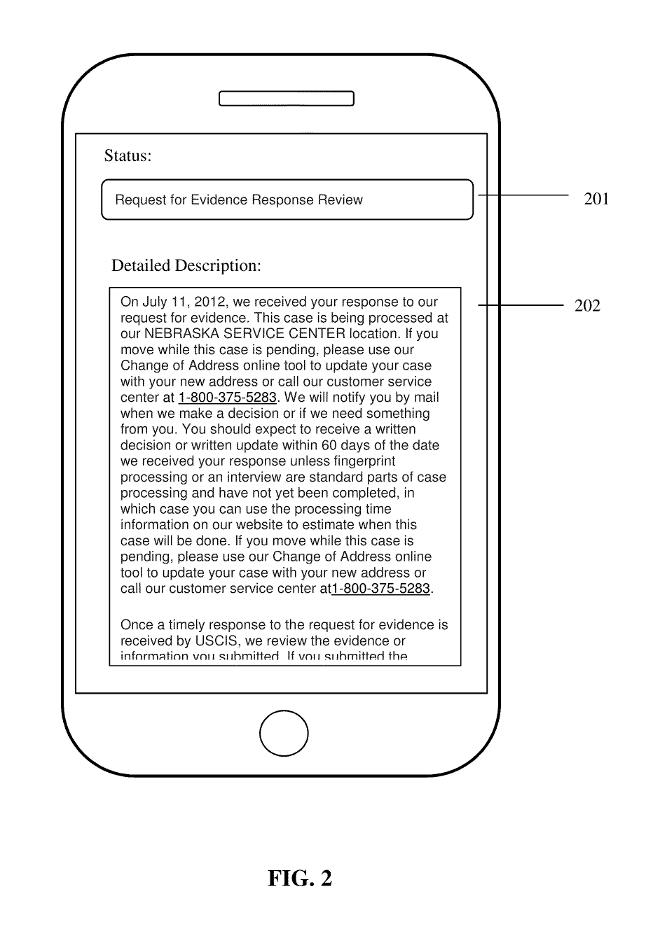

FIG. 2 is an example of a typical embodiment of the USCIS application status displayed on a smartphone.
201 The USCIS application status.
202 The detailed USCIS application status description.

What is claimed is:

1. A method implemented on portable electronic device to check USCIS application status, comprising:
collecting a USCIS receipt number for an immigration related application on a portable electronic device through an input dialog;
retrieving said application's status; and
displaying said application's status on said portable electronic device.

2. The method according to claim 1, further comprising:
retrieving a detailed application status description for said immigration related application; and
displaying said detailed application status description on said portable electronic device.

3. The method of any of claims 1 to 2, wherein said input dialog is in a language other than English.

4. The method of any of claims 1 to 2, wherein said input dialog is in Chinese.

5. The method of any of claims 1 to 2, wherein said application status is provided in a language other than English.

6. The method of any of claims 1 to 2, wherein said application status is provided in Chinese

7. The method of any of claims 1 to 2, wherein said detailed application status description is provided in language other than English.

8. The method of any of claims 1 to 2, wherein said detailed application status description is provided in Chinese.

9. The method of any of claims 1 to 2, wherein said portable electronic device is a smartphone.
